(19) United States
(12) Patent Application Publication
(10) Pub. No.: US 2026/0119388 A1
(43) Pub. Date: Apr. 30, 2026

(54) DOMAIN MANAGEMENT DEVICE ALLOCATING SUPER BLOCK, AND METHOD OF OPERATING THE SAME

(71) Applicant: SAMSUNG ELECTRONICS CO., LTD., Suwon-si (KR)

(72) Inventors: Hyejin JANG, Suwon-si (KR); Jingeun Park, Suwon-si (KR); Heongwon Lee, Suwon-si (KR); Joonyong Jeong, Suwon-si (KR)

(73) Assignee: SAMSUNG ELECTRONICS CO., LTD., Suwon-si (KR)

(21) Appl. No.: 19/293,784

(22) Filed: Aug. 7, 2025

(30) Foreign Application Priority Data
Oct. 24, 2024 (KR) 10-2024-0146270

(51) Int. Cl. G06F 12/02

(52) U.S. Cl. CPC G06F 12/023; G06F 2212/1036

(57) ABSTRACT

Disclosed is a method of operating a domain management device which communicates with a non-volatile memory device. The method includes counting a number of initial bad blocks included in a plurality of memory chips of a first domain of the non-volatile memory device, respectively, selecting a first memory chip among the plurality of memory chips based on the number of initial bad blocks, replacing the first memory chip of the first domain with a second memory chip of a second domain of the non-volatile memory device, and allocating at least one super block of a reserved area to an over-provisioning area, in the first domain including the replaced second memory chip.

### CROSS-REFERENCE TO RELATED APPLICATIONS

This application claims priority under 35 U.S.C. § 119 to Korean Patent Application No. 10-2024-0146270 filed on Oct. 24, 2024, in the Korean Intellectual Property Office, the disclosures of which are incorporated by reference herein in their entireties.

### BACKGROUND

Embodiments of the present disclosure described herein relate to a management method of a non-volatile memory device, and more particularly, relate to a domain management device allocating a super block, and a method of operating the same.

A memory device stores data in response to a write request and outputs data stored therein in response to a read request. For example, the memory device is classified as a volatile memory device, which loses data stored therein when a power is turned off, such as a dynamic random access memory (DRAM) device or a static RAM (SRAM) device, or a non-volatile memory device, which retains data stored therein even when a power is turned off, such as a flash memory device, a phase-change RAM (PRAM), a magnetic RAM (MRAM), or a resistive RAM (RRAM).

The non-volatile memory device may include a plurality of memory chips. Each of the plurality of memory chips may include a plurality of memory blocks. Some of the plurality of memory blocks may be initial bad blocks due to the manufacturing process. The plurality of memory chips may be managed in units of domain. The domain may allocate a reserved area based on the initial bad blocks. The reserved area may not store data.

### SUMMARY

Embodiments of the present disclosure provide a domain management device allocating a super block, and a method of operating the same.

According to an aspect of the present disclosure, a method of operating a domain management device which communicates with a non-volatile memory device, may include: counting a number of initial bad blocks included in a plurality of memory chips of a first domain of the non-volatile memory device, respectively; selecting a first memory chip among the plurality of memory chips based on the number of initial bad blocks; replacing the first memory chip of the first domain with a second memory chip of a second domain of the non-volatile memory device; and allocating at least one super block of a reserved area to an over-provisioning area, in the first domain including the replaced second memory chip.

According to another aspect of the present disclosure, a method of operating a domain management device which communicates with a non-volatile memory device, may include: counting a number of initial bad blocks included in a plurality of memory chips in a first domain and a second domain of the non-volatile memory device, respectively; distributing a plurality of bad memory chips identified from the plurality of memory chips, between the first domain and the second domain based on the number of initial bad blocks; performing a disk format operation on the first domain and the second domain to which the plurality of bad memory chips are distributed; and after the disk format operation, allocating super blocks of a reserved area of the first domain and the second domain to an over-provisioning area; classifying the super blocks into a first type of supporting a full super block function and a second type of supporting a partial super block function; and using a first super block classified as the first type or a second super block classified as the second type based on a workload of the non-volatile memory device.

According to another aspect of the present disclosure, a domain management device may include: a memory chip information table configured to store first domain chip information and second domain chip information of a first domain and a second domain included in a non-volatile memory device, respectively; and at least one processor configured to: count a number of initial bad blocks included in a plurality of memory chips of the first domain, respectively; update the first domain chip information based on the counted number of initial bad blocks; select a first memory chip from the plurality of memory chips in the first domain, and a second memory chip from a plurality of memory chips in the second domain based on the first domain chip information and the second domain chip information; replace the first memory chip of the first domain with the second memory chip; update the first domain chip information and the second domain chip information to reflect a result of replacing the first memory chip with the second memory chip; and allocate at least one super block of a reserved area to an over-provisioning area, in the first domain including the replaced second memory chip.

### BRIEF DESCRIPTION OF THE DRAWINGS

The above and other objects and features of the present disclosure will become apparent by describing in detail embodiments thereof with reference to the accompanying drawings.

FIG. 1 is a block diagram of an electronic device according to an embodiment of the present disclosure.

FIG. 2 is a block diagram describing a non-volatile memory device of FIG. 1, according to some embodiments of the present disclosure.

FIG. 3 is a block diagram describing a domains of FIG. 1, according to some embodiments of the present disclosure.

FIG. 4 is a graph describing the tendency of memory chips and initial bad blocks, according to some embodiments of the present disclosure.

FIG. 5A is a diagram describing a default domain setting of a domain according to some embodiments of the present disclosure.

FIG. 5B is a diagram describing an optimized domain setting of a domain according to some embodiments of the present disclosure.

FIG. 6A is a diagram describing a default domain setting of a multi-domain according to some embodiments of the present disclosure.

FIG. 6B is a diagram describing an optimized domain setting of a multi-domain according to some embodiments of the present disclosure.

FIG. 6C is a diagram describing an optimized domain setting with a swap function of a multi-domain according to some embodiments of the present disclosure.

FIG. 7 is a diagram describing a method of operating an electronic device according to some embodiments of the present disclosure.

FIG. 8 is a flowchart describing a method of operating an electronic device according to some embodiments of the present disclosure.

FIG. 9 is a block diagram of an electronic device according to some embodiments of the present disclosure.

FIG. 10 is a block diagram of an electronic device according to some embodiments of the present disclosure.

FIG. 11 is a block diagram describing an electronic device of FIG. 10, according to some embodiments of the present disclosure.

FIG. 12 is a flowchart describing a method of operating an electronic device according to some embodiments of the present disclosure.

### DETAILED DESCRIPTION

Below, embodiments of the present disclosure will be described in detail and clearly to such an extent that one skilled in the art carries out embodiments of the present disclosure easily.

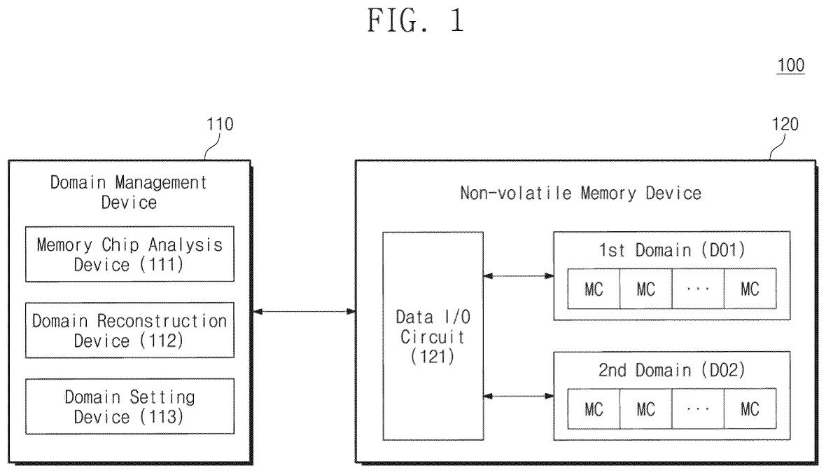

FIG. 1 is a block diagram of an electronic device according to an embodiment of the present disclosure. Referring to FIG. 1, an electronic device 100 may include a domain management device 110 and a non-volatile memory device 120. The electronic device 100 may be a semiconductor manufacturing system manufacturing the non-volatile memory device 120. Alternatively, the electronic device 100 may be a storage device including the non-volatile memory device 120.

The domain management device 110 may communicate with the non-volatile memory device 120. The domain management device 110 may include a memory chip analysis device 111, a domain reconstruction device 112, and a domain setting device 113.

The domain management device 110 may manage domains (e.g., a first domain DO1 and a second domain DO2) of the non-volatile memory device 120, and may be implemented by one or more processors. The domain may refer to a plurality of memory chips MC. The memory chip MC may include a plurality of memory blocks. The memory block may include a plurality of memory cells (e.g., memory cell transistors) storing data. The domain may support a super block function for accessing memory blocks respectively included in the corresponding memory chips MC in parallel (e.g., simultaneously or partially simultaneously). The super block may refer to a set of memory blocks accessible in parallel.

The domain management device 110 may be implemented by hardware, software, or a combination thereof. For example, the domain management device 110 may be implemented with a separate hardware device for managing the domains of the non-volatile memory device 120. As another example, a non-transitory computer-readable storage medium may store instructions corresponding to the domain management device 110. When a processor loads the instructions and executes the loaded instructions, the instructions may allow the processor to perform at least some of functions corresponding to the domain management device 110.

The memory chip analysis device 111 may analyze the memory chips MC of the domains of the non-volatile memory device 120. For example, some of the memory blocks corresponding to the memory chip MC may be initial bad blocks, and the others thereof may be normal blocks. The memory chip analysis device 111 may count the number of initial bad blocks of the memory chip MC and may store the information about the number of initial bad blocks in the non-volatile memory device 120. The initial bad block may refer to a memory block including a permanent defect which may result from the manufacturing process of the non-volatile memory device 120. The initial bad block may be incapable of storing data or retrieving data due to defect or malfunction. The normal block may refer to a memory block capable of storing and retrieving data normally.

A memory chip MC that includes initial bad blocks, with their number exceeding a predetermined chip threshold number, may be referred to as a “bad memory chip”. The chip threshold number may be predetermined by various factors such as a standard of the non-volatile memory device 120, performance of a domain, and the number of memory blocks included in the memory chip MC. A memory chip MC that includes initial bad blocks, with their number less than or equal to the predetermined chip threshold number, or does not include an initial bad block, may be referred to as a “normal memory chip”. In the present disclosure, a bad block and a bad memory chip may be also referred to as a faulty block and a faulty memory chip, respectively.

The domain reconstruction device 112 may reconstruct the domains of the non-volatile memory device 120 such that bad memory chips are uniform or are distributed almost uniformly. For example, the domain reconstruction device 112 may identify a domain including many bad memory chips, may identify a domain including few bad memory chips, and may swap a bad memory chip of the domain including more bad memory chips and a normal memory chip of the domain including few bad memory chips. The swap may refer to replacing memory chips with each other.

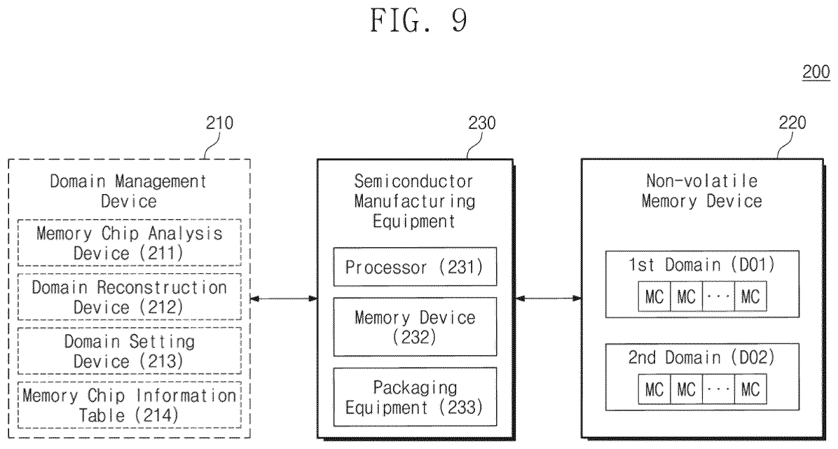

In some embodiments, memory chips of domains may be replaced or swapped using a physical method as part of the manufacturing process. This will be described in detail with reference to FIG. 9.

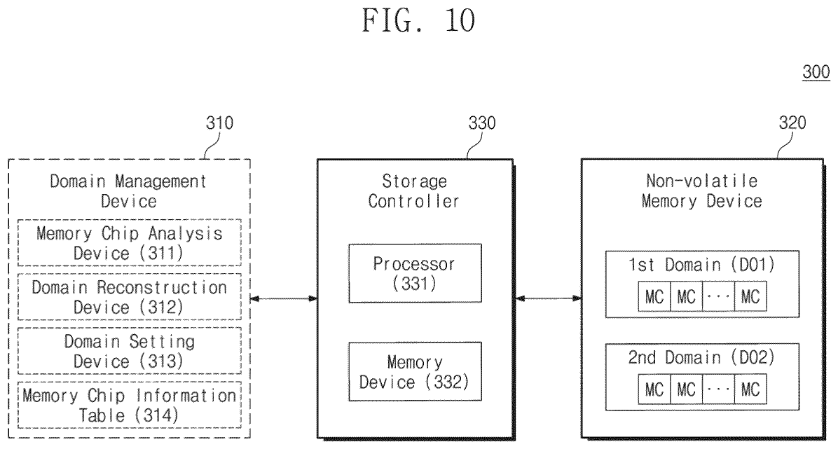

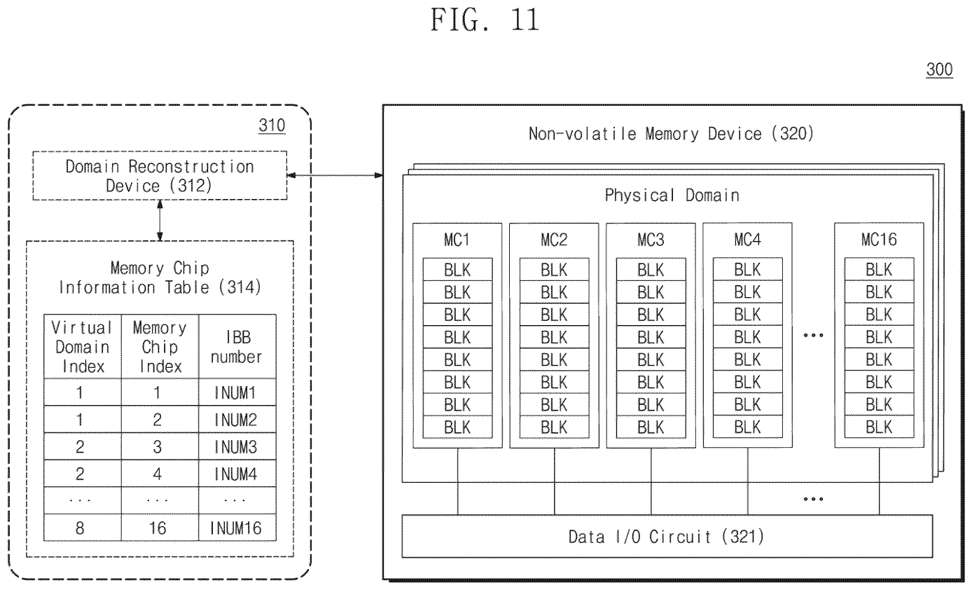

In some embodiments, memory chips of domains may be replaced or swapped using a logical method, which involves changing a mapping relationship between a domain and a memory chip by a storage controller configured to manage or control the non-volatile memory device 120. This will be described in detail with reference to FIGS. 10 and 11.

The domain setting device 113 may manage a user area and a reserved area of a domain. The user area may refer to a logical space for storing data or performing an operation associated with the data. The reserved area may refer to a logical space which is not used and is preliminarily allocated.

The domain setting device 113 may set a ratio of the user area and the reserved area based on the number of initial bad blocks of the memory chips MC corresponding to a domain. After the domains are reconstructed by the domain reconstruction device 112, the domain setting device 113 may again set the ratio of the user area and the reserved area based on the number of initial bad blocks of the memory chips MC thus changed.

The non-volatile memory device 120 may store data. The non-volatile memory device 120 may include a data input/output (I/O) circuit 121, the first domain DO1, and the second domain DO2. Each of the first and second domains DO1 and DO2 may include the plurality of memory chips MC. The first and second domains DO1 and DO2 are described for better understanding of the present disclosure, but the non-volatile memory device 120 may include three or more domains.

For example, the non-volatile memory device 120 may be a NAND flash memory. However, the present disclosure is not limited thereto, and the non-volatile memory device 120 may be implemented with one of various storage devices, which are able to retain data stored therein even though a power is turned off, such as a phase-change random access memory (PRAM), a magnetic random access memory (MRAM), a resistive random access memory (RRAM), and a ferroelectric random access memory (FRAM).

The data I/O circuit 121 may receive data from an external device (e.g., a host device or a storage controller). The data I/O circuit 121 may provide the data to the first domain DO1 or the second domain DO2. The data I/O circuit 121 may receive data from the first domain DO1 or the second domain DO2. The data I/O circuit 121 may provide the data to the external device (e.g., a host device or a storage controller).

In some embodiments, the data I/O circuit 121 may communicate with a domain in units of super block. For example, the data I/O circuit 121 may provide data to the memory blocks respectively included in the memory chips MC of the first domain DO1 in parallel or may receive data from the memory blocks respectively included in the memory chips MC of the first domain DO1 in parallel.

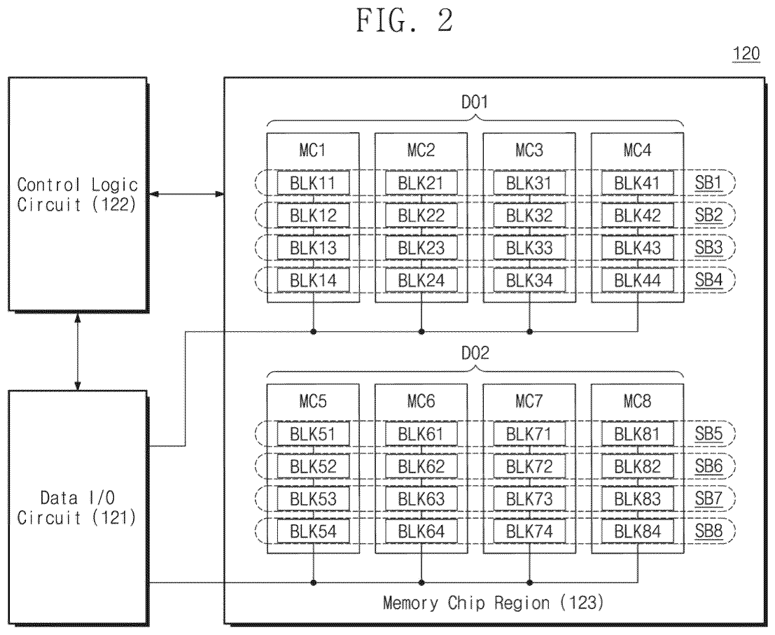

FIG. 2 is a block diagram describing a non-volatile memory device of FIG. 1, according to some embodiments of the present disclosure. Referring to FIGS. 1 and 2, the non-volatile memory device 120 may include the data I/O circuit 121, a control logic circuit 122, and a memory chip region 123. The non-volatile memory device 120 may manage data under control of a storage controller.

Under control of the control logic circuit 122, the data I/O circuit 121 may provide data received from the storage controller to the memory chip region 123 or may provide data received from the memory chip region 123 to the storage controller.

The control logic circuit 122 may receive a command and an address from the storage controller. The command may be used to indicate an operation to be performed in the non-volatile memory device 120. The address may be used to identify a memory chip or a memory block in which the operation corresponding to the command will be performed. The control logic circuit 122 may control the data I/O circuit 121 and the memory chip region 123 based on the command and the address.

The memory chip region 123 may include the first domain DO1 and the second domain DO2. The first domain DO1 may include first to fourth memory chips MC1, MC2, MC3, and MC4. The first memory chip MC1 may include memory blocks BLK11, BLK12, BLK13, and BLK14. The second memory chip MC2 may include memory blocks BLK21, BLK22, BLK23, and BLK24. The third memory chip MC3 may include memory blocks BLK31, BLK32, BLK33, and BLK34. The fourth memory chip MC4 may include memory blocks BLK41, BLK42, BLK43, and BLK44.

The memory blocks BLK11, BLK21, BLK31, and BLK41 may be collectively referred to as a “first super block SB1”. As in the above description, the memory blocks BLK12, BLK22, BLK32, and BLK42 may be collectively referred to as a “second super block SB2”, the memory blocks BLK13, BLK23, BLK33, and BLK43 may be collectively referred to as a “third super block SB3”, and the memory blocks BLK14, BLK24, BLK34, and BLK44 may be collectively referred to as a “fourth super block SB4”.

The second domain DO2 may include fifth to eighth memory chips MC5, MC6, MC7, and MC8. The fifth memory chip MC5 may include memory blocks BLK51, BLK52, BLK53, and BLK54. The sixth memory chip MC6 may include memory blocks BLK61, BLK62, BLK63, and BLK64. The seventh memory chip MC7 may include memory blocks BLK71, BLK72, BLK73, and BLK74. The eighth memory chip MC8 may include memory blocks BLK81, BLK82, BLK83, and BLK84.

The memory blocks BLK51, BLK61, BLK71, and BLK81 may be collectively referred to as a “fifth super block SB5”. As in the above description, the memory blocks BLK52, BLK62, BLK72, and BLK82 may be collectively referred to as a “sixth super block SB6”, the memory blocks BLK53, BLK63, BLK73, and BLK83 may be collectively referred to as a “seventh super block SB7”, and the memory blocks BLK54, BLK64, BLK74, and BLK84 may be collectively referred to as an “eighth super block SB8”.

The first and second domains DO1 and DO2 may support the super block function. The super block function may refer to outputting data in parallel by memory blocks corresponding to a super block or storing data in parallel in memory blocks corresponding to a super block. The super block function may include a full super block function and a partial super block function.

The full super block function may refer to accessing all memory blocks corresponding to a super block in parallel. For example, when all the memory blocks BLK11, BLK21, BLK31, and BLK41 corresponding to the first super block SB1 are normal blocks, the first domain DO1 may support the full super block function for accessing the memory blocks BLK11, BLK21, BLK31, and BLK41, which are respectively included in the first to fourth memory chips MC1, MC2, MC3, and MC4, in parallel. The full super block function may have a wide data bandwidth and a low latency.

The partial super block function may refer to accessing some normal blocks among memory blocks corresponding to a super block in parallel. For example, when some of the memory blocks BLK11, BLK21, BLK31, and BLK41 corresponding to the first super block SB1 are initial bad blocks and when the number of initial bad blocks is smaller than a function threshold number, the first domain DO1 may support the partial super block function for accessing the remaining normal blocks (i.e., others) among the memory blocks BLK11, BLK21, BLK31, and BLK41, which are respectively included in the first to fourth memory chips MC1, MC2, MC3, and MC4, in parallel. A data bandwidth of the partial super block function may be narrower than that of the full super block function, and a latency of the partial super block function may be higher than that of the full super block function.

As another example, when some of the memory blocks BLK11, BLK21, BLK31, and BLK41 corresponding to the first super block SB1 are initial bad blocks and when the number of initial bad blocks is equal to or greater than the function threshold number, the first domain DO1 may not support the super block function in the first super block SB1. The normal block of the first super block SB1 may be handled as a redundant memory block (e.g., a spare memory block not contributing to data storage).

For better understanding of the present disclosure, the description is given as each of the first and second domains DO1 and DO2 includes four memory chips and a memory chip includes four memory blocks, but the present disclosure is not limited thereto. The number of memory chips included in a domain may be more than or less than “4”. The number of memory blocks included in a memory chip may be more than or less than “4”. Also, the non-volatile memory device 120 may include any other domain(s) (e.g., a third domain) in addition to the first and second domains DO1 and DO2.

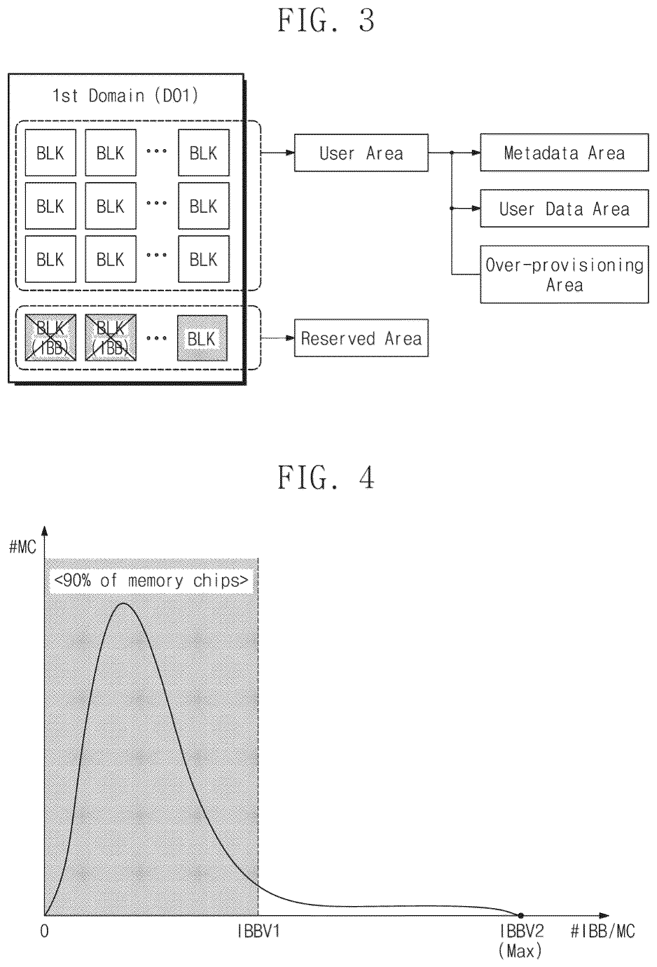

FIG. 3 is a block diagram describing a domains of FIG. 1, according to some embodiments of the present disclosure. Referring to FIGS. 1 and 3, the first domain DO1 may include the plurality of memory chips MC. The plurality of memory chips MC may include a plurality of memory blocks BLK. Some of the plurality of memory blocks BLK may be initial bad blocks IBB, and the others thereof may be normal blocks. The initial bad blocks IBB may be generated by the process of manufacturing the non-volatile memory device 120.

The plurality of memory blocks BLK of the first domain DO1 may provide the user area and the reserved area. In a logical space which the first domain DO1 is capable of providing, the remaining space other than the reserved area may be allocated as the user area. The user area may include a metadata area, a user data area, and an over-provisioning area.

The metadata area may store metadata for user data. The metadata may include information describing the user data. For example, the metadata may include the following information of a file corresponding to the user data: a time when the file is generated, a location where the file is generated, a location where the file is stored, a writer, and a revision time.

The user data area may store the user data. The user data may include information of contents to be provided to the user of the non-volatile memory device 120. For example, the user data may include information such as image data, video data, text data, and an application.

The over-provisioning area may be used to manage the user data and the metadata safely and to perform the background operation for improving the endurance of a device (e.g., the non-volatile memory device 120). The over-provisioning area may not be identified by the user of the non-volatile memory device 120. The over-provisioning area may be provided separately from the user data area. For example, the over-provisioning area may provide a storage space for the garbage collection operation or the wear leveling operation associated with the user data and the metadata.

When the over-provisioning area is not sufficient, the garbage collection operation or the wear leveling operation may not be performed normally. In this case, the performance (e.g., a storage capacity, a read speed, a write speed, and the reliability of stored data) of the non-volatile memory device 120 may be reduced. To guarantee the required performance of the non-volatile memory device 120, a portion of the whole area of the first domain DO1, which has a given size or more, is required as the over-provisioning area.

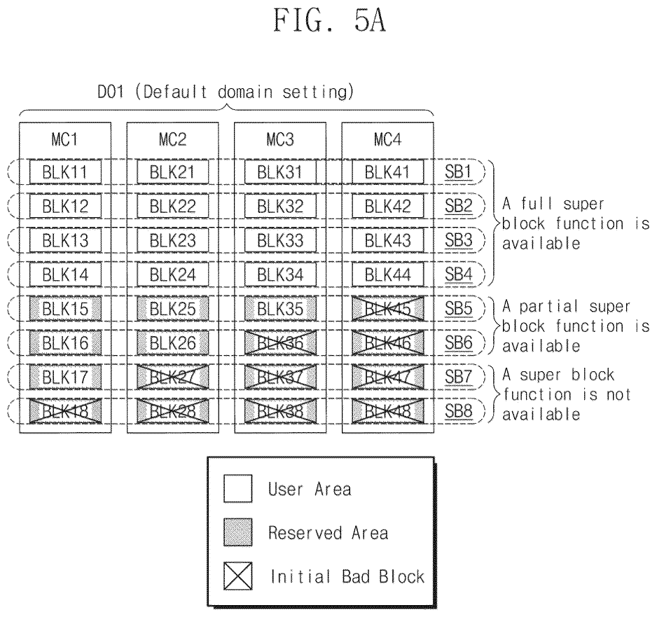

The reserved area may be allocated based on the initial bad block IBB. For example, the reserved area may be allocated based on the maximum number of initial bad blocks IBB capable of being generated from among the plurality of memory blocks BLK of the first domain DO1. The reserved area may include the memory block BLK which is not the initial bad block IBB. This will be described in detail with reference to FIG. 4.

FIG. 4 is a graph describing the tendency of memory chips and initial bad blocks, according to some embodiments of the present disclosure. A relationship between the memory chip MC and the initial bad block IBB will be described with reference to FIGS. 1 and 4. In FIG. 4, the horizontal axis represents the number of initial bad blocks IBB per memory chip MC, and the vertical axis represents the number of memory chips MC.

Due to a process error or a physical limitation, the number of initial bad blocks IBB may differ depending on the memory chips MC of the non-volatile memory device 120. According to some embodiments, in 90% of the memory chips MC of the non-volatile memory device 120, the number of initial bad blocks IBB per memory chip MC may be between “0” and a first initial bad block value IBBV1. In 10% of the memory chips MC of the non-volatile memory device 120, the number of initial bad blocks IBB per memory chip MC may be between the first initial bad block value IBBV1 and a second initial bad block value IBBV2.

In the first and second domains DO1 and DO2, the reserved area may be allocated widely based on the second initial bad block value IBBV2. The widely allocated reserved area may cause a decrease of the user area. However, most memory chips MC (e.g., about 90% of the memory chips MC) include initial bad blocks IBB, the number of which is smaller than the first initial bad block value IBBV1. As a result, the reserved area may include many normal blocks stochastically (or in general). The domain setting device 113 may increase the user area by allocating a normal block(s) from the reserved area to the user area.

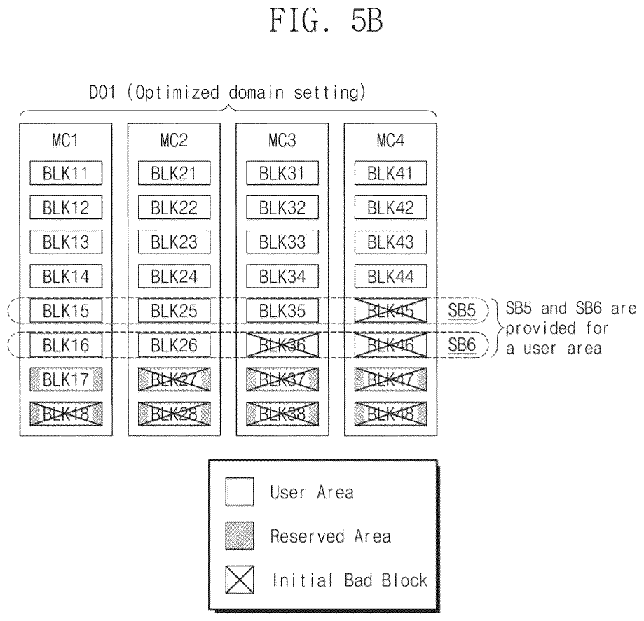

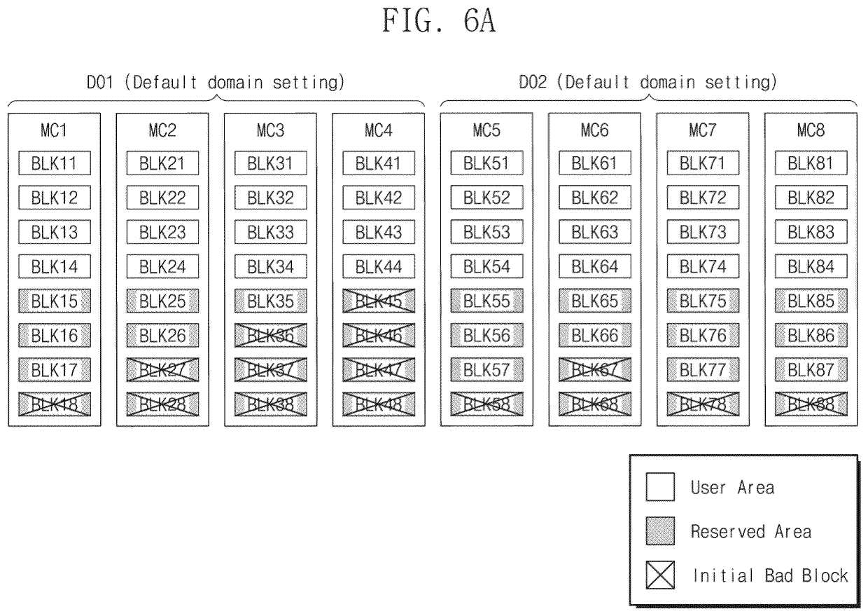

FIG. 5A is a diagram describing a default domain setting of a domain according to some embodiments of the present disclosure. The first domain DO1 having a default domain setting will be described with reference to FIG. 5A. The first domain DO1 may include the first to fourth memory chips MC1, MC2, MC3, and MC4. The first memory chip MC1 may include memory blocks BLK11, BLK12, BLK13, BLK14, BLK15, BLK16, BLK17, and BLK18. The second memory chip MC2 may include memory blocks BLK21, BLK22, BLK23, BLK24, BLK25, BLK26, BLK27, and BLK28. The third memory chip MC3 may include memory blocks BLK31, BLK32, BLK33, BLK34, BLK35, BLK36, BLK37, and BLK38. The fourth memory chip MC4 may include memory blocks BLK41, BLK42, BLK43, BLK44, BLK45, BLK46, BLK47, and BLK48.

The first super block SB1 may include the memory blocks BLK11, BLK21, BLK31, and BLK41. As in the above description, the second super block SB2 may include the memory blocks BLK12, BLK22, BLK32, and BLK42, the third super block SB3 may include the memory blocks BLK13, BLK23, BLK33, and BLK43, the fourth super block SB4 may include the memory blocks BLK14, BLK24, BLK34, and BLK44, the fifth super block SB5 may include the memory blocks BLK15, BLK25, BLK35, and BLK45, the sixth super block SB6 may include the memory blocks BLK16, BLK26, BLK36, and BLK46, the seventh super block SB7 may include the memory blocks BLK17, BLK27, BLK37, and BLK47, and the eighth super block SB8 may include the memory blocks BLK18, BLK28, BLK38, and BLK48.

The fifth to eighth super blocks SB5 to SB8 may be allocated to the reserved area based on the maximum number of initial bad blocks (e.g., 16 initial bad blocks) capable of being generated in the first domain DO1. The number of initial bad blocks of the first domain DO1 (e.g., 10 initial bad blocks) may be smaller than the maximum number of initial bad blocks capable of being generated (e.g., 16 initial bad blocks). The first to fourth super blocks SB1, SB2, SB3, and SB4 not allocated to the reserved area may be allocated to the user area. The user area may include the over-provisioning area. For convenience of description, the user area is not shaded, the reserved area is shaded, and the initial bad block is marked by “x”.

The first to fourth super blocks SB1, SB2, SB3, and SB4 may support the full super block function. For example, the first to fourth super blocks SB1, SB2, SB3, and SB4 may not include an initial bad block. Because all the memory blocks of the first to fourth super blocks SB1, SB2, SB3, and SB4 are normal blocks capable of storing data, the full super block function may be available in the first to fourth super blocks SB1, SB2, SB3, and SB4.

The fifth and sixth super blocks SB5 and SB6 may support the partial super block function. For example, the function threshold number for the partial super block function may be “3”. Because the fifth super block SB5 includes one initial bad block (i.e., the memory block BLK45), the number of which is smaller than “3” being the function threshold number, the fifth super block SB5 may support the partial super block function. Because the sixth super block SB6 includes two initial bad blocks (i.e., the memory blocks BLK36 and BLK46), the number of which is smaller than “3” being the function threshold number, the sixth super block SB6 may support the partial super block function. That is, the fifth and sixth super blocks SB5 and SB6 may be capable of supporting the partial super block function.

The seventh and eighth super blocks SB7 and SB8 not may support the super block function. For example, the function threshold number for the partial super block function may be “3”. Because the seventh super block SB7 includes three initial bad blocks (i.e., the memory blocks BLK27, BLK37, and BLK47), the number of which is not smaller than “3” being the function threshold number, the seventh super block SB7 may not support the partial super block function. Because the eighth super block SB8 includes four initial bad blocks (i.e., the memory blocks BLK18, BLK28, BLK38, and BLK48), the number of which is not smaller than “3” being the function threshold number, the eighth super block SB8 may not support the partial super block function. That is, the super block function may be unavailable in the seventh and eighth super blocks SB7 and SB8.

The first domain DO1 may operate depending on the default domain setting. In the default domain setting, because the fifth and sixth super blocks SB5 and SB6 are allocated to the reserved area, the fifth and sixth super blocks SB5 and SB6 may fail to contribute to data storage. In other words, the fifth and sixth super blocks SB5 and SB6 supporting the partial super block function may not be utilized in the first domain DO1.

FIG. 5B is a diagram describing an optimized domain setting of a domain according to some embodiments of the present disclosure. The first domain DO1 having an optimized domain setting will be described with reference to FIG. 5B. The domain setting device 113 of FIG. 1 may assign the optimized domain setting to the first domain DO1. The correspondence relationship between the domain DO1, the memory chips MC1, MC2, MC3, and MC4, the memory blocks BLK11 to BLK48, and the super blocks SB5 and SB6 is similar to that described with reference to FIG. 5A, and thus, additional description will be omitted to avoid redundancy.

The fifth and sixth super blocks SB5 and SB6 may support the partial super block function. The allocation of the fifth and sixth super blocks SB5 and SB6 to the reserved area may cause the waste of the storage capacity. The domain setting device 113 of FIG. 1 may assign the optimized domain setting to the first domain DO1 by allocating the fifth and sixth super blocks SB5 and SB6 of the reserved area to the user area (e.g., the over-provisioning area).

In the optimized domain setting, the fifth and sixth super blocks SB5 and SB6 may be allocated to the user area (e.g., the over-provisioning area). Based on the partial super block function, the fifth and sixth super blocks SB5 and SB6 may store the metadata, may store the user data, or may provide the over-provisioning area. The storage capacity of the first domain DO1 may increase by adding the fifth and sixth super blocks SB5 and SB6 supporting the partial super block function to the user area (e.g., the over-provisioning area).

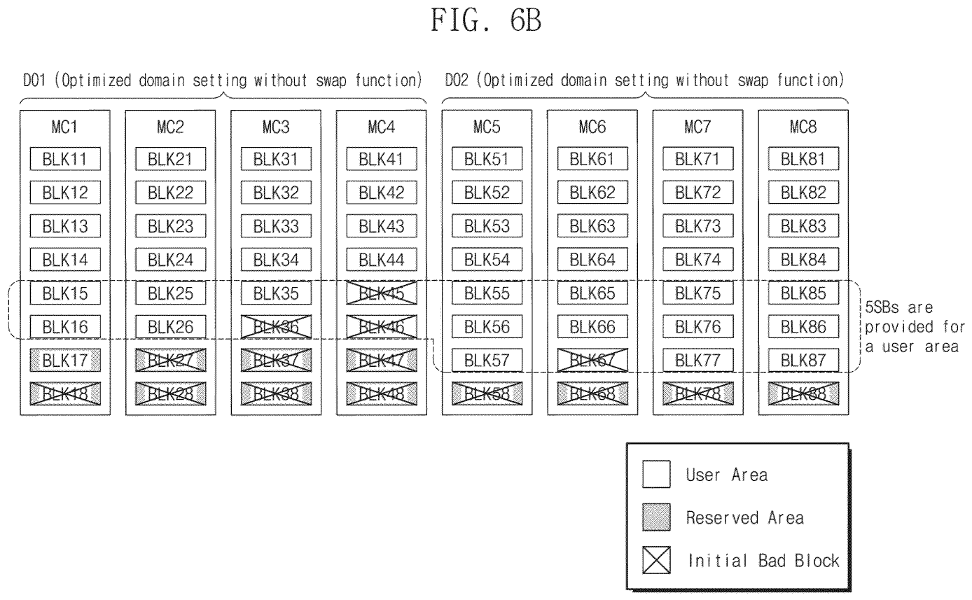

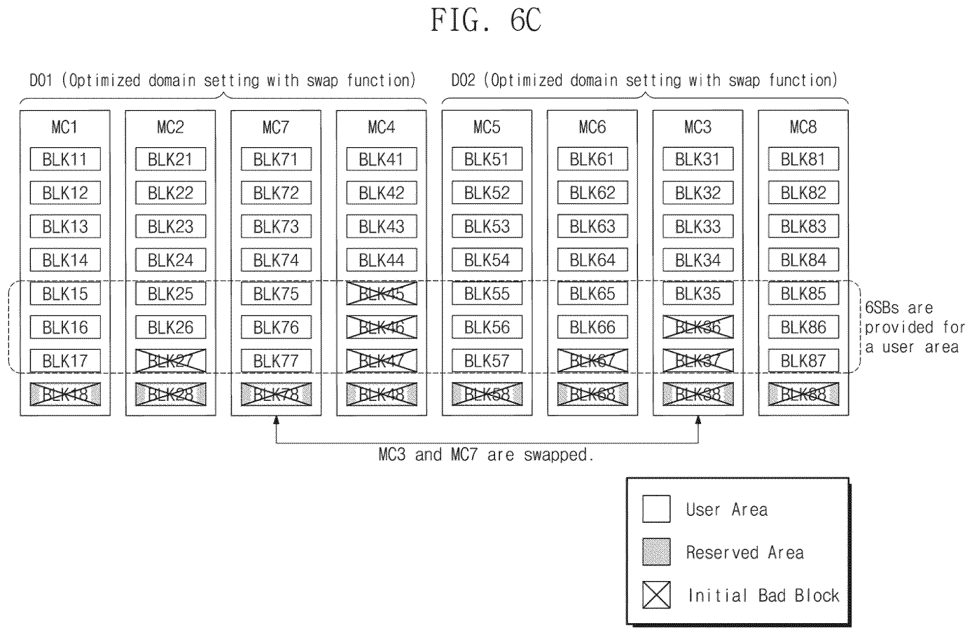

FIG. 6A is a diagram describing a default domain setting of a multi-domain according to some embodiments of the present disclosure. The first and second domains DO1 and DO2 having a default domain setting will be described with reference to FIG. 6A.

The first domain DO1 may include the first to fourth memory chips MC1, MC2, MC3, and MC4. The first memory chip MC1 may include the memory blocks BLK11, BLK12, BLK13, BLK14, BLK15, BLK16, BLK17, and BLK18. The second memory chip MC2 may include the memory blocks BLK21, BLK22, BLK23, BLK24, BLK25, BLK26, BLK27, and BLK28. The third memory chip MC3 may include the memory blocks BLK31, BLK32, BLK33, BLK34, BLK35, BLK36, BLK37, and BLK38. The fourth memory chip MC4 may include the memory blocks BLK41, BLK42, BLK43, BLK44, BLK45, BLK46, BLK47, and BLK48.

In the first domain DO1, a set of memory blocks disposed at the same row may be referred to as a “super block”. For example, the memory blocks BLK11, BLK21, BLK31, and BLK41 may be referred to as a “super block”. As in the above description, the memory blocks BLK12, BLK22, BLK32, and BLK42 may be referred to as a “super block”.

The second domain DO2 may include the fifth to eighth memory chips MC5, MC6, MC7, and MC8. The fifth memory chip MC5 may include memory blocks BLK51, BLK52, BLK53, BLK54, BLK55, BLK56, BLK57, and BLK58. The sixth memory chip MC6 may include memory blocks BLK61, BLK62, BLK63, BLK64, BLK65, BLK66, BLK67, and BLK68. The seventh memory chip MC7 may include memory blocks BLK71, BLK72, BLK73, BLK74, BLK75, BLK76, BLK77, and BLK78. The eighth memory chip MC8 may include memory blocks BLK81, BLK82, BLK83, BLK84, BLK85, BLK86, BLK87, and BLK88.

In the second domain DO2, a set of memory blocks disposed at the same row may be referred to as a “super block”. For example, the memory blocks BLK51, BLK61, BLK71, and BLK81 may be referred to as a “super block”. As in the above description, the memory blocks BLK52, BLK62, BLK72, and BLK82 may be referred to as a “super block”.

The memory blocks BLK11 to BLK88 of the first and second domains DO1 and DO2 may be allocated to the user area or the reserved area. The user area may include the over-provisioning area. Some of the memory blocks BLK11 to BLK88 may be initial bad blocks. For convenience of description, the user area is not shaded, the reserved area is shaded, and the initial bad block is marked by “x”.

Referring to the reserved area of the first domain DO1, the super block including the memory blocks BLK15, BLK25, BLK35, and BLK45 may support the partial super block function. The super block including the memory blocks BLK16, BLK26, BLK36, and BLK46 may support the partial super block function.

Referring to the reserved area of the second domain DO2, the super block including the memory blocks BLK55, BLK65, BLK75, and BLK85 may support the full super block function. The super block including the memory blocks BLK56, BLK66, BLK76, and BLK86 may support the full super block function. The super block including the memory blocks BLK57, BLK67, BLK77, and BLK87 may support the partial super block function.

Because super blocks each supporting the partial super block function or the full super block function are allocated to the reserved area, the optimized domain setting for expanding the user area (e.g., the over-provisioning area) may be required.

FIG. 6B is a diagram describing an optimized domain setting of a multi-domain according to some embodiments of the present disclosure. The first and second domains DO1 and DO2 having the optimized domain setting without a swap function will be described with reference to FIG. 6B. The domain setting device 113 of FIG. 1 may assign the optimized domain setting without a swap function to the first and second domains DO1 and DO2. The correspondence relationship between the domains DO1 and DO2, the memory chips MC1 to MC8, the memory blocks BLK11 to BLK88, and the super blocks is similar to that described with reference to FIG. 6A, and thus, additional description will be omitted to avoid redundancy.

Referring to the first domain DO1, the super block including the memory blocks BLK15, BLK25, BLK35, and BLK45 may be allocated to the user area (e.g., the over-provisioning area). The super block including the memory blocks BLK16, BLK26, BLK36, and BLK46 may be allocated to the user area (e.g., the over-provisioning area).

Referring to the second domain DO2, the super block including the memory blocks BLK55, BLK65, BLK75, and BLK85 may be allocated to the user area (e.g., the over-provisioning area). The super block including the memory blocks BLK56, BLK66, BLK76, and BLK86 may be allocated to the user area (e.g., the over-provisioning area). The super block including the memory blocks BLK57, BLK67, BLK77, and BLK87 may be allocated to the user area (e.g., the over-provisioning area).

In other words, as the optimized domain setting without a swap function is assigned to the first and second domains DO1 and DO2, five super blocks may be further provided to the user area (e.g., the over-provisioning area). However, when the swap of memory chips in the first and second domains DO1 and DO2 is permitted, a super block supporting the super block function may be further allocated to the user area (e.g., the over-provisioning area). This will be described in detail with reference to FIG. 6C.

FIG. 6C is a diagram describing an optimized domain setting with a swap function of a multi-domain according to some embodiments of the present disclosure. The first and second domains DO1 and DO2 having the optimized domain setting together with a swap function will be described with reference to FIG. 6C. The domain reconstruction device 112 and the domain setting device 113 of FIG. 1 may assign the optimized domain setting to the first and second domains DO1 and DO2 together with a swap function. The correspondence relationship between the domains DO1 and DO2, the memory chips MC1 to MC8, the memory blocks BLK11 to BLK88, and the super blocks is similar to that described with reference to FIG. 6A, and thus, additional description will be omitted to avoid redundancy.

The domain reconstruction device 112 of FIG. 1 may swap the third memory chip MC3 of the first domain DO1 with the seventh memory chip MC7 of the second domain DO2. That is, the third memory chip MC3 of the first domain DO1 may be replaced with the seventh memory chip MC7, and the seventh memory chip MC7 of the second domain DO2 may be replaced with the third memory chip MC3. After the swap, the first domain DO1 may include the first memory chip MC1, the second memory chip MC2, the fourth memory chip MC4, and the seventh memory chip MC7. The second domain DO2 may include the third memory chip MC3, the fifth memory chip MC5, the sixth memory chip MC6, and the eighth memory chip MC8.

Referring to the first domain DO1 including the replaced seventh memory chip MC7, the super block including the memory blocks BLK15, BLK25, BLK75, and BLK45 may support the partial super block function. The super block including the memory blocks BLK16, BLK26, BLK76, and BLK46 may support the partial super block function. The super block including the memory blocks BLK17, BLK27, BLK77, and BLK47 may support the partial super block function. The domain setting device 113 of FIG. 1 may allocate super blocks supporting the super block function to the user area (e.g., the over-provisioning area).

Referring to the second domain DO2 including the replaced third memory chip MC3, the super block including the memory blocks BLK55, BLK65, BLK35, and BLK85 may support the full super block function. The super block including the memory blocks BLK56, BLK66, BLK36, and BLK86 may support the partial super block function. The super block including the memory blocks BLK57, BLK67, BLK37, and BLK87 may support the partial super block function. The domain setting device 113 of FIG. 1 may allocate super blocks supporting the super block function to the user area (e.g., the over-provisioning area).

In other words, after swapping the third memory chip MC3 of the first domain DO1 with the seventh memory chip MC7 of the second domain DO2 through the swap function, super blocks of the first and second domains DO1 and DO2, which support the super block function, may be allocated to the user area (e.g., the over-provisioning area), and thus, six super blocks may be further provided to the user area (e.g., the over-provisioning area). Referring to FIGS. 6B and 6C, as the swap function is permitted, the number of super blocks provided to the user area (e.g., the over-provisioning area) may increase.

In some embodiments, the domain reconstruction device 112 of FIG. 1 may distribute bad memory chips uniformly or almost uniformly in the multi-domain environment. For example, before the swap, the first domain DO1 may include the first to fourth memory chips MC1, MC2, MC3, and MC4, and the second domain DO2 may include the fifth to eighth memory chips MC5, MC6, MC7, and MC8.

In an embodiment, the third and fourth memory chips MC3 and MC4 including initial bad blocks, the number of which exceeds “2” being the chip threshold number, from among the first to eighth memory chips MC1 to MC8 may be referred to as “bad memory chips”. Before the swap, the first domain DO1 may include two bad memory chips, and the second domain DO2 may not include a bad memory chip. That is, the bad memory chips may be focused on the first domain DO1.

The domain reconstruction device 112 of FIG. 1 may select the third memory chip MC3 including initial bad blocks, the number of which is the second greatest, from among bad memory chips of the first domain DO1, may select the seventh memory chip MC7 being one of normal memory chips of the second domain DO2, and may swap the third memory chip MC3 with the seventh memory chip MC7. According to the above description, two bad memory chips focused on the first domain DO1 may be uniformly distributed to the first and second domains DO1 and DO2.

As bad memory chips are uniformly distributed to the first and second domains DO1 and DO2, a super block supporting the super block function may be additionally secured in the reserved area of the first and second domains DO1 and DO2. As the domain setting device 113 of FIG. 1 allocates the additionally secured super block to the user area (e.g., the over-provisioning area), it may be possible to increase the storage capacity of the non-volatile memory device 120 of FIG. 1 and to guarantee the required performance of the non-volatile memory device 120.

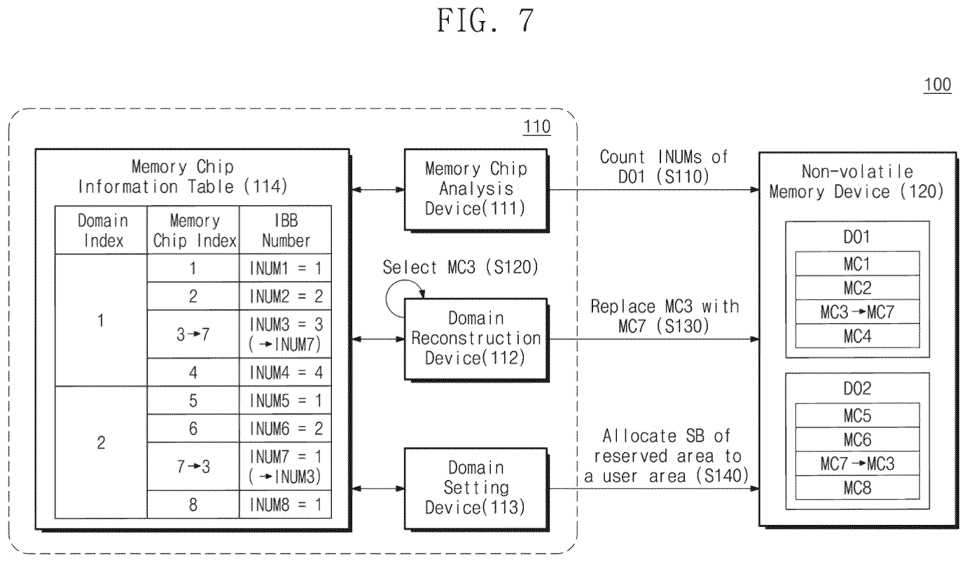

FIG. 7 is a diagram describing a method of operating an electronic device according to some embodiments of the present disclosure. Referring to FIG. 7, the electronic device 100 may include the domain management device 110 and the non-volatile memory device 120. The domain management device 110 may communicate with the non-volatile memory device 120.

The non-volatile memory device 120 may include the first domain DO1 and the second domain DO2. The first domain DO1 may include first to N-th memory chips, and the second domain DO2 may include (N+1)-th to 2N-th memory chips. “N” may indicate the number of memory chips allocated to a domain. “N” is an arbitrary natural number. For example, “N” may be “4”.

The domain management device 110 may manage first and second domains DO1 and DO2 of the non-volatile memory device 120. The domain management device 110 may include the memory chip analysis device 111, the domain reconstruction device 112, the domain setting device 113, and a memory chip information table 114.

The memory chip analysis device 111 may analyze the first to eighth memory chips MC1 to MC8 of the non-volatile memory device 120 and may store first to eighth initial bad block numbers INUM1 to INUM8 of the first to eighth memory chips MC1 to MC8 in the memory chip information table 114. The initial bad block number may indicate the number of initial bad blocks counted in the corresponding memory chip.

The domain reconstruction device 112 may change memory chips included in the first domain DO1 of the non-volatile memory device 120. The domain reconstruction device 112 may change memory chips included in the second domain DO2 of the non-volatile memory device 120.

The domain setting device 113 may set the user area and the reserved area of the first domain DO1. The domain setting device 113 may set the user area and the reserved area of the second domain DO2.

The memory chip information table 114 may store first to fourth memory chip information (or referred to as first domain chip information) respectively corresponding to the first to fourth memory chips MC1, MC2, MC3, and MC4 of the first domain DO1. The memory chip information table 114 may store fifth to eighth memory chip information (or referred to as second domain chip information) respectively corresponding to the fifth to eighth memory chips MC5, MC6, MC7, and MC8 of the second domain DO2.

Memory chip information may include a domain index value, a memory chip index value, and an initial bad block number. For example, the first memory chip information may include the domain index value of “1” indicating the first domain DO1 to which the first memory chip MC1 belongs, the memory chip index value of “1” for identifying the first memory chip MC1, and the first initial bad block number INUM1 indicating “1” being the number of initial bad blocks of the first memory chip MC1.

Below, a method of operating the electronic device 100 will be described.

In operation S110, the memory chip analysis device 111 may count first to fourth initial bad block numbers respectively corresponding to first to N-th memory chips of the first domain DO1 and may update first to N-th memory chip information of the memory chip information table 114 based on the first to fourth initial bad block numbers.

For example, N may be “4”. The memory chip analysis device 111 may count the first to fourth initial bad block numbers INUM1, INUM2, INUM3, and INUM4 respectively corresponding to the first to fourth memory chips MC1, MC2, MC3, and MC4 of the first domain DO1. The first to fourth initial bad block numbers INUM1, INUM2, INUM3, and INUM4 may be “1”, “2”, “3”, and “4”, respectively. The memory chip analysis device 111 may update first to fourth memory chip information of the memory chip information table 114 based on the first to fourth initial bad block numbers INUM1, INUM2, INUM3, and INUM4.

In some embodiments, independently of operation S110 and before operation S120, the memory chip analysis device 111 may count (N+1)-th to 2N-th initial bad block numbers respectively corresponding to (N+1)-th to 2N-th memory chips of the second domain DO2 and may update (N+1)-th to 2N-th memory chip information of the memory chip information table 114 based on the (N+1)-th to 2N-th initial bad block numbers.

In operation S120, the domain reconstruction device 112 may select one of the first to N-th memory chips based on first to N-th initial bad block numbers corresponding to the first domain DO1. The domain reconstruction device 112 may select one of the (N+1)-th to 2N-th memory chips based on the (N+1)-th to 2N-th initial bad block numbers corresponding to the second domain DO2.

For example, the domain reconstruction device 112 may select the third memory chip MC3 among the first to fourth memory chips MC1, MC2, MC3, and MC4, based on the first to fourth initial bad block numbers INUM1, INUM2, INUM3, and INUM4 of the first to fourth memory chip information of the memory chip information table 114. For example, the domain reconstruction device 112 may select the seventh memory chip MC7 among the fifth to eighth memory chips MC5, MC6, MC7, and MC8, based on the fifth to eighth initial bad block numbers INUM5, INUM6, INUM7, and to INUM8 of the fifth to eighth memory chip information of the memory chip information table 114.

In some embodiments, the domain reconstruction device 112 may distribute bad memory chips uniformly or almost uniformly in the multi-domain environment. For example, the multi-domain including the first and second domains DO1 and DO2 may include the first to eighth memory chips MC1 to MC8. The third and fourth memory chips MC3 and MC4 each including initial bad blocks, the number of which exceeds the chip threshold number of “2”, from the first to eighth memory chips MC1 to MC8 may be referred to as “bad memory chips”. The first domain DO1 may include two bad memory chips, and the second domain DO2 may not include a bad memory chip.

To distribute bad memory chips focused on the first domain DO1 to the first and second domains DO1 and DO2, the domain reconstruction device 112 may select the third memory chip MC3 among the first to fourth memory chips MC1, MC2, MC3, and MC4 based on the first to fourth initial bad block numbers INUM1, INUM2, INUM3, and INUM4 corresponding to the first domain DO1 and may select the seventh memory chip MC7 from among the fifth to eighth memory chips MC5, MC6, MC7, and MC8 based on the fifth to eighth initial bad block numbers INUM5, INUM6, INUM7, and INUM8 corresponding to the second domain DO2.

In detail, the domain reconstruction device 112 may select the third and fourth initial bad block numbers INUM3 and INUM4 respectively corresponding to the bad memory chips from among the first to fourth initial bad block numbers INUM1, INUM2, INUM3, and INUM4, may select the third initial bad block number INUM3 being the second greatest number from among the selected third and fourth initial bad block numbers INUM3 and INUM4, and may select the third memory chip MC3 corresponding to the third initial bad block number INUM3.

The domain reconstruction device 112 may select the fifth to eighth initial bad block numbers INUM5, INUM6, INUM7, and INUM8 respectively corresponding to the normal memory chips from among the fifth to eighth initial bad block numbers INUM5, INUM6, INUM7, and INUM8, may select the seventh initial bad block number INUM7 being an arbitrary initial bad block number from among the selected fifth to eighth initial bad block numbers INUM5, INUM6, INUM7, and INUM8, and may select the seventh memory chip MC7 corresponding to the seventh initial bad block number INUM7.

In operation S130, the domain reconstruction device 112 may replace the third memory chip MC3 of the first domain DO1 with the seventh memory chip MC7 of the second domain DO2. The seventh initial bad block number INUM7 (e.g., “1”) corresponding to the seventh memory chip MC7 may be smaller than the third initial bad block number INUM3 (e.g., “3”) corresponding to the third memory chip MC3. For example, the domain reconstruction device 112 may swap the third memory chip MC3 with the seventh memory chip MC7.

In some embodiments, the third memory chip MC3 of the first domain DO1 may be replaced or swapped with the seventh memory chip MC7 of the second domain DO2 using a physical method as part of the manufacturing process, or using a logical method, which involves changing the mapping relationship between a domain and a memory chip by a storage controller controlling the non-volatile memory device 120.

According to the above description, the first domain DO1 may include the first memory chip MC1, the second memory chip MC2, the fourth memory chip MC4, and the seventh memory chip MC7. The second domain DO2 may include the third memory chip MC3, the fifth memory chip MC5, the sixth memory chip MC6, and the eighth memory chip MC8. In the first domain DO1, the number of super blocks supporting the super block function may increase by replacing the third memory chip MC3 being a bad memory chip with the seventh memory chip MC7. In the second domain DO2, the number of super blocks supporting the super block function may be maintained even though the seventh memory chip MC7 is replaced with the third memory chip MC3 being a bad memory chip.

That is, in the multi-domain environment including the first and second domains DO1 and DO2, the number of super blocks supporting the super block function may increase.

In some embodiments, the domain reconstruction device 112 may update memory chip information corresponding to the replaced memory chips in the memory chip information table 114. For example, the domain reconstruction device 112 may replace the third memory chip MC3 of the first domain DO1 with the seventh memory chip MC7 of the second domain DO2 and may then update the third and seventh memory chip information corresponding to the third and seventh memory chips MC3 and MC7 in the memory chip information table 114.

In detail, the updated third memory chip information may include the domain index value of “2” indicating the second domain DO2, the memory chip index value of “3” for identifying the third memory chip MC3, and the third initial bad block number INUM3. As in the above description, the updated seventh memory chip information may include the domain index value of “1” indicating the first domain DO1, the memory chip index value of “7” for identifying the seventh memory chip MC7, and the seventh initial bad block number INUM7.

In operation S140, in the first domain DO1 including the replaced seventh memory chip MC7, the domain setting device 113 may allocate at least one super block of the reserved area to the user area (e.g., the over-provisioning area). In the second domain DO2 including the replaced third memory chip MC3, the domain setting device 113 may allocate at least one super block of the reserved area to the user area (e.g., the over-provisioning area).

For example, based on the memory chip information table 114, that is, based on the first, second, fourth, and seventh memory chip information corresponding to the first domain DO1, the domain setting device 113 may identify at least one super block supporting the super block function from among super blocks of the reserved area and may allocate the identified at least one super block to the user area (e.g., the over-provisioning area).

Likewise, based on the memory chip information table 114, that is, based on the third, fifth, sixth, and eighth memory chip information corresponding to the second domain DO2, the domain setting device 113 may identify at least one super block supporting the super block function from among super blocks of the reserved area and may allocate the identified at least one super block to the user area (e.g., the over-provisioning area).

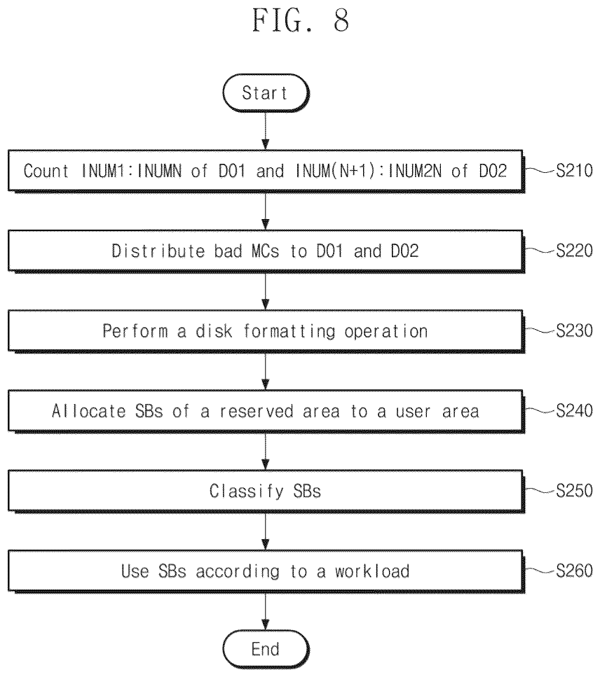

FIG. 8 is a flowchart describing a method of operating an electronic device according to some embodiments of the present disclosure. Referring to FIG. 8, an electronic device may include a domain management device and a non-volatile memory device.

In operation S210, the domain management device may count first to 2N-th initial bad block numbers INUM1 to INUM2N respectively corresponding to first to 2N-th memory chips. The non-volatile memory device may include the first domain DO1 and the second domain DO2. The first domain DO1 may include first to N-th memory chips. Each of the first to N-th initial bad block numbers INUM1 to INUMN may indicate the number of initial bad blocks of each of the first to N-th memory chips. The second domain DO2 may include (N+1)-th to 2N-th memory chips. Each of the (N+1)-th to 2N-th initial bad block numbers INUM(N+1) to INUM2N may indicate the number of initial bad blocks of each of the (N+1)-th to 2N-th memory chips.

In some embodiments, the domain management device may identify bad memory chips among the first to 2N-th memory chips based on the first to 2N-th initial bad block numbers INUM1 to INUM2N. The bad memory chip may refer to a memory chip corresponding to initial bad block numbers each exceeding a chip threshold number.

In operation S220, the domain management device may identify bad memory chips among the first to 2N-th memory chips based on the first to 2N-th initial bad block numbers INUM1 to INUM2N and may distribute the identified bad memory chips to the first domain DO1 and the second domain DO2.

For example, the distribution of the bad memory chips may include selecting a first memory chip of the first domain DO1, selecting the (N+1)-th memory chip of the second domain DO2, and swapping the first and (N+1)-th memory chips.

In some embodiments, the domain management device may identify a domain with a higher number of bad memory chips than an average bad memory chip count across multi-domains and may distribute the bad memory chips from the identified domain to another domain.

For example, the domain management device may determine memory chips corresponding to initial bad block numbers each exceeding the chip threshold number from among the first to N-th memory chips of the first domain DO1 as bad memory chips. The first memory chip may be a bad memory chip. The domain management device may determine whether the number of bad memory chips of the first domain DO1 exceeds “M”. In an embodiment, “M” may indicate the average number of bad memory chips per domain in the environment of the multi-domain including the first and second domains DO1 and DO2.

In an embodiment, the number of bad memory chips of the first domain DO1 may exceed “M”, and the number of bad memory chips of the second domain DO2 may be smaller than “M”. The domain management device may select a first memory chip of the first domain DO1 in response to determining that the number of bad memory chips of the first domain DO1 exceeds “M”. The first memory chip may be a bad memory chip. The domain management device may select the (N+1)-th memory chip among the (N+1)-th to 2N-th memory chips of the second domain DO2. The (N+1)-th memory chip may be a normal memory chip. The domain management device may swap the first memory chip with the (N+1)-th memory chip.

In some embodiments, the domain management device may distribute bad memory chips uniformly or almost uniformly, between the first and second domains DO1 and DO2. For example, the domain management device may identify memory chips, from among the first to 2N-th memory chips, that have initial bad block numbers each exceeding the chip threshold number as bad memory chips. The domain management device may distribute or allocate half of the bad memory chips to the first domain DO1 and the remaining half to the second domain DO2.

In operation S230, the domain management device may perform a disk format operation of the first and second domains DO1 and DO2 including a plurality of distributed bad memory chips.

After the domain management device performs the disk format operation, in operation S240, the domain management device may allocate super blocks of the reserved area of the first and second domains DO1 and DO2 to the user area (e.g., the over-provisioning area). For example, the domain management device may identify at least one super block supporting the super block function from among the super blocks of the reserved area and may allocate the identified at least one super block to the user area (e.g., the over-provisioning area). The super block function may include the full super block function and the partial super block function.

In operation S250, the domain management device may classify the allocated super blocks. For example, each of the allocated super blocks may support the full super block function or the partial super block function. The domain management device may classify the allocated super blocks into a first type of supporting the full super block function and a second type of supporting the partial super block function.

In operation S260, the domain management device may use a first super block classified as the first type or a second super block classified as the second type depending on a workload of the non-volatile memory device. For example, the workload may be suitable for at least one of the user data area, the metadata area, and the over-provisioning area. The domain management device may select the first type or the second type based on the workload. For the user data area, the metadata area, and the over-provisioning area, the domain management device may use the first super block corresponding to the first type or the second super block corresponding to the second type. That is, the domain management device may use a super block whose type is suitable for the workload.

FIG. 9 is a block diagram of an electronic device according to some embodiments of the present disclosure. Referring to FIG. 9, an electronic device 200 may include a domain management device 210, a non-volatile memory device 220, and semiconductor manufacturing equipment 230. The electronic device 200 may be referred to as a “semiconductor manufacturing system”.

The domain management device 210 may include a memory chip analysis device 211, a domain reconstruction device 212, a domain setting device 213, and a memory chip information table 214. The memory chip analysis device 211, the domain reconstruction device 212, the domain setting device 213, and the memory chip information table 214 are similar to the memory chip analysis device 111, the domain reconstruction device 112, the domain setting device 113, and the memory chip information table 114, and thus, additional description will be omitted to avoid redundancy.

The non-volatile memory device 220 may include the first domain DO1 and the second domain DO2. Each of the first and second domains DO1 and DO2 may include the plurality of memory chips MC. The memory chips MC of the first domain DO1 may include first to N-th memory chips. The memory chips MC of the second domain DO2 may include (N+1)-th to 2N-th memory chips.

The semiconductor manufacturing equipment 230 may manufacture the non-volatile memory device 220. The semiconductor manufacturing equipment 230 may include a processor 231, a memory device 232, and packaging equipment 233. The semiconductor manufacturing equipment 230 may implement the domain management device 210 implemented as a software module. For example, the processor 231 may implement the domain management device 210 by loading instructions stored in the memory device 232 and executing the loaded instructions.

In some embodiments, the way to swap memory chips of domains may be implemented by a physical method as a part of the manufacturing process. For example, the first domain DO1 may include the first to N-th memory chips. The second domain DO2 may include the (N+1)-th to 2N-th memory chips. The domain reconstruction device 212 may select the first memory chip of the first domain DO1 and the (N+1)-th memory chip of the second domain DO2. Afterwards, the domain reconstruction device 212 may be configured to control the packaging equipment 233 such that the second to N-th memory chips and the (N+1)-th memory chip are packaged. This may mean that the second to N-th memory chips and the (N+1)-th memory chip constitute the first domain DO1. The domain reconstruction device 212 may be configured to control the packaging equipment 233 such that the first and the (N+2)-th to 2N-th memory chips are packaged. This may mean that the first and the (N+2)-th to 2N-th memory chips constitute the second domain DO2.

FIG. 10 is a block diagram of an electronic device according to some embodiments of the present disclosure. Referring to FIG. 10, an electronic device 300 may include a domain management device 310, a non-volatile memory device 320, and a storage controller 330. The electronic device 300 may be referred to as a “storage device”.

The domain management device 310 may include a memory chip analysis device 311, a domain reconstruction device 312, a domain setting device 313, and a memory chip information table 314. The memory chip analysis device 311, the domain reconstruction device 312, the domain setting device 313, and the memory chip information table 314 are similar to the memory chip analysis device 111, the domain reconstruction device 112, the domain setting device 113, and the memory chip information table 114, and thus, additional description will be omitted to avoid redundancy.

The non-volatile memory device 320 may include the first domain DO1 and the second domain DO2. Each of the first and second domains DO1 and DO2 may include the plurality of memory chips MC. The memory chips MC of the first domain DO1 may include first to N-th memory chips. The memory chips MC of the second domain DO2 may include (N+1)-th to 2N-th memory chips.

The storage controller 330 may control the non-volatile memory device 320. For example, depending on a request of an external host device, the storage controller 330 may store data received from the external host device in the non-volatile memory device 320, may provide the data stored in the non-volatile memory device 320 to the external host device, or may delete the data stored in the non-volatile memory device 320.

The storage controller 330 may include a processor 331 and a memory device 332. The storage controller 330 may implement the domain management device 310 implemented as a software module or a firmware module. For example, the processor 331 may implement the domain management device 310 by loading instructions stored in the memory device 332 and executing the loaded instructions.

In some embodiments, the way to swap memory chips of domains may be implemented by a logical method of changing a mapping relationship between a domain and a memory chip by the storage controller 330 controlling the non-volatile memory device 320. The logical method will be described in detail with reference to FIG. 11.

FIG. 11 is a block diagram describing an electronic device of FIG. 10, according to some embodiments of the present disclosure. Referring to FIGS. 10 and 11, the electronic device 300 may include the domain management device 310 and the non-volatile memory device 320. The domain management device 310 may include the domain reconstruction device 312 and the memory chip information table 314. The non-volatile memory device 320 may include a data I/O circuit 321 and a plurality of physical domains. An embodiment of one physical domain will be described for better understanding of the present disclosure.

The physical domain may include first to sixteenth memory chips MC1 to MC16. Each of the first to sixteenth memory chips MC1 to MC16 may include a plurality of memory blocks BLK. The number of memory chips of the physical domain is provided as an example, and the number of memory chips of the physical domain may be more than or less than 16.

The first to sixteenth memory chips MC1 to MC16 of the physical domain may be identified as a plurality of virtual domains. For example, the first and second memory chips MC1 and MC2 may be allocated to a first virtual domain. The third and fourth memory chips MC3 and MC4 may be allocated to a second virtual domain. The number of memory chips allocated to the virtual domain is provided as an example, and the virtual domain may include two or more memory chips. The virtual domains may correspond to the first and second domains DO1 and DO2 of FIG. 10.

The memory chip information table 314 may store first to sixteenth memory chip information respectively corresponding to the first to sixteenth memory chips MC1 to MC16 included in the physical domain.

The memory chip information may include a virtual domain index value, a memory chip index value, and an initial bad block number. For example, the first memory chip information may include the virtual domain index value of “1” indicating the first virtual domain to which the first memory chip MC1 belongs, the memory chip index value of “1” for identifying the first memory chip MC1, and the first initial bad block number INUM1 of the first memory chip MC1.

In some embodiments, the domain reconstruction device 312 may swap memory chips of domains by using the logical method. For example, the non-volatile memory device 320 may include the physical domain. The physical domain may include first to 2N memory chips. The first to N-th memory chips may be allocated to the first virtual domain. The (N+1)-th to 2N-th memory chips may be allocated to the second virtual domain.

For the swap, the domain reconstruction device 312 may select the first memory chip of the first virtual domain and the (N+1)-th memory chip of the second virtual domain. Afterwards, the domain reconstruction device 312 may set the virtual domain index value corresponding to the first memory chip in the memory chip information table 314 to a value indicating the second virtual domain instead of the first virtual domain and may update the first memory chip information corresponding to the first memory chip.

As in the above description, the domain reconstruction device 312 may set the virtual domain index value corresponding to the (N+1)-th memory chip in the memory chip information table 314 to a value indicating the first virtual domain instead of the second virtual domain and may update the (N+1)-th memory chip information corresponding to the (N+1)-th memory chip.

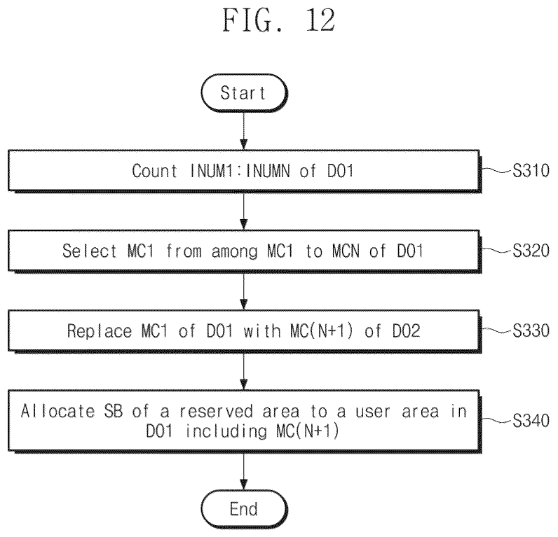

FIG. 12 is a flowchart describing a method of operating an electronic device according to some embodiments of the present disclosure. Referring to FIG. 12, an electronic device may include a domain management device and a non-volatile memory device. The domain management device may communicate with the non-volatile memory device. The non-volatile memory device may include the first domain DO1 and the second domain DO2. The first domain DO1 may include the first to N-th memory chips MC1 to MCN. The second domain DO2 may include the (N+1)-th to 2N-th memory chips MC(N+1) to MC2N. In an embodiment, “N” may be an arbitrary natural number indicating the number of memory blocks included in a domain.

In operation S310, the domain management device may count the first to N-th initial bad block numbers INUM1 to INUMN respectively corresponding to the first to N-th memory chips MC1 to MCN of the first domain DO1.

In operation S320, the domain management device may select the first memory chip MC1 among the first to N-th memory chips MC1 to MCN of the first domain DO1, based on the first to N-th initial bad block numbers INUM1 to INUMN. For example, the first initial bad block number INUM1 may exceed the chip threshold number. The first memory chip MC1 may be selected as a bad memory chip.

In operation S330, the domain management device may replace the first memory chip MC1 of the first domain DO1 with the (N+1)-th memory chip MC(N+1) of the second domain DO2. The (N+1)-th initial bad block number INUM(N+1) corresponding the (N+1)-th memory chip MC(N+1) may be smaller than the first initial bad block number INUM1. For example, the (N+1)-th initial bad block number INUM(N+1) may not exceed the chip threshold number. The (N+1)-th memory chip MC(N+1) may be a normal memory chip.

In operation S340, the domain management device may allocate at least one super block of the reserved area to the user area (e.g., the over-provisioning area), in the first domain DO1 including the replaced (N+1)-th memory chip MC(N+1). Accordingly, the storage capacity of the non-volatile memory device may be increased.

According to an embodiment of the present disclosure, a domain management device allocating a super block and a method of operating the same are provided.

Also, as bad memory chips are uniformly distributed in a multi-domain environment, super blocks to be provided to an over-provisioning area may be additionally secured. Accordingly, the storage capacity of the non-volatile memory device may be increased.

While the present disclosure has been described with reference to embodiments thereof, it will be apparent to those of ordinary skill in the art that various changes and modifications may be made thereto without departing from the spirit and scope of the present disclosure as set forth in the following claims.

What is claimed is:

1. A method of operating a domain management device which communicates with a non-volatile memory device, the method comprising:
counting a number of initial bad blocks included in a plurality of memory chips of a first domain of the non-volatile memory device, respectively;
selecting a first memory chip among the plurality of memory chips based on the number of initial bad blocks;
replacing the first memory chip of the first domain with a second memory chip of a second domain of the non-volatile memory device; and
allocating at least one super block of a reserved area to an over-provisioning area, in the first domain including the replaced second memory chip.

2. The method of claim 1, wherein the first domain is configured to support:
a full super block function for accessing memory blocks of each of the plurality of memory chips in parallel; and
a partial super block function for accessing some of the memory blocks in parallel.

3. The method of claim 1, wherein the initial bad blocks comprise at least one initial bad block having a defect caused by a manufacturing process of the non-volatile memory device.

4. The method of claim 1, wherein the selecting of the first memory chip comprises:
among the plurality of memory chips in the first domain, identifying a memory chip in which the number of initial bad block exceeds a chip threshold number as a bad memory chip,
wherein the number of initial bad blocks in the first memory chip exceeds the chip threshold number, and
wherein the chip threshold number corresponds to an average bad memory chip number of a plurality of domains comprising the first domain and the second domain.

5. The method of claim 4, wherein the number of initial bad blocks in the second domain is less than the chip threshold number, and
wherein the number of initial bad blocks in the second memory chip is less than the chip threshold number.

6. The method of claim 1, wherein the selecting of the first memory chip comprises:
selecting the first memory chip in which the number of initial bad blocks is a second greatest among the plurality of memory chips in the first domain.

7. The method of claim 1, wherein the domain management device is included in semiconductor manufacturing equipment configured to manufacture the non-volatile memory device,
wherein the semiconductor manufacturing equipment comprises a processor and a memory device, and
wherein the processor is configured to operate as the domain management device or interoperate with the domain management device by loading instructions stored in the memory device and executing the loaded instructions.

8. The method of claim 7, wherein the semiconductor manufacturing equipment further comprises packaging equipment, and
wherein the replacing of the first memory chip in the first domain with the second memory chip in the second domain of the non-volatile memory device comprises:
controlling the packaging equipment to package the plurality of memory chips of the first domain, excluding the first memory chip, and the replaced second memory chip in the first domain.

9. The method of claim 1, wherein a storage device comprises a storage controller and the non-volatile memory device,
wherein the storage controller comprises a processor and a memory device, and
wherein the processor is configured to operate as the domain management device or interoperate with the domain management device by loading instructions stored in the memory device and executing the loaded instructions.

10. The method of claim 9, wherein the non-volatile memory device comprises a physical domain,
wherein the physical domain comprises the plurality of memory chips of the first domain and the second memory chip of the second domain, and
wherein the replacing of the first memory chip of the first domain with the second memory chip of the second domain comprises:
setting a virtual domain index value corresponding to the first memory chip to a value indicating the second domain; and
setting a virtual domain index value corresponding to the second memory chip to a value indicating the first domain.

11. The method of claim 1, wherein the over-provisioning area provides a storage space for a garbage collection operation or a wear leveling operation.

12. The method of claim 1, wherein the allocated at least one super block comprises a plurality of super blocks, and
wherein the method further comprises:
classifying the plurality of super blocks into a first type of supporting a full super block function and a second type of supporting a partial super block function;
selecting the first type or the second type based on a workload; and
using a first super block corresponding to the first type or a second super block corresponding to the second type, for a user data area, a metadata area, or the over-provisioning area.

13. A method of operating a domain management device which communicates with a non-volatile memory device, the method comprising:
counting a number of initial bad blocks included in a plurality of memory chips in a first domain and a second domain of the non-volatile memory device, respectively;
distributing a plurality of bad memory chips identified from the plurality of memory chips, between the first domain and the second domain based on the number of initial bad blocks;
performing a disk format operation on the first domain and the second domain to which the plurality of bad memory chips are distributed;
after the disk format operation, allocating super blocks of a reserved area of the first domain and the second domain to an over-provisioning area;
classifying the super blocks into a first type of supporting a full super block function and a second type of supporting a partial super block function; and
using a first super block classified as the first type or a second super block classified as the second type based on a workload of the non-volatile memory device.

14. The method of claim 13, wherein the distributing of the plurality of bad memory chips comprises:
among the plurality of memory chips, identifying memory chips in which the number of initial bad block exceeds a chip threshold number as the plurality of bad memory chips;
distributing half of the plurality of bad memory chips to the first domain; and
distributing a remaining half of the plurality of bad memory chips to the second domain.

15. The method of claim 13, wherein the using of the first super block classified as the first type or the second super block classified as the second type based on the workload comprises:
selecting the first type or the second type based on the workload; and
using the first super block corresponding to the first type or the second super block corresponding to the second type, for a user data area, a metadata area, or the over-provisioning area.

16. A domain management device comprising:
a memory chip information table configured to store first domain chip information and second domain chip information of a first domain and a second domain included in a non-volatile memory device, respectively; and
at least one processor configured to:
count a number of initial bad blocks included in a plurality of memory chips of the first domain, respectively;
update the first domain chip information based on the counted number of initial bad blocks;
select a first memory chip from the plurality of memory chips in the first domain, and a second memory chip from a plurality of memory chips in the second domain based on the first domain chip information and the second domain chip information;
replace the first memory chip of the first domain with the second memory chip;
update the first domain chip information and the second domain chip information to reflect a result of replacing the first memory chip with the second memory chip; and
allocate at least one super block of a reserved area to an over-provisioning area, in the first domain including the replaced second memory chip.

17. The domain management device of claim 16, the non-volatile memory device comprises a processor and a memory device, and
wherein the processor is configured to operate as the domain management device or interoperate with the domain management device by loading instructions stored in the memory device and executing the loaded instructions.

18. The domain management device of claim 16, wherein a storage device comprises a storage controller and the non-volatile memory device,
wherein the storage controller comprises a processor and a memory device, and
wherein the processor is configured to operate as the domain management device or interoperate with the domain management device by loading instructions stored in the memory device and executing the loaded instructions.

19. The domain management device of claim 16, wherein the over-provisioning area provides a storage space for a garbage collection operation or a wear leveling operation.

20. The domain management device of claim 16, wherein the initial bad blocks comprise at least one initial bad block having a defect caused by a manufacturing process of the non-volatile memory device.
